(19) United States
(12) Patent Application Publication
(10) Pub. No.: US 2018/0306108 A1
(43) Pub. Date: Oct. 25, 2018

(54) SLIDING LINEAR INTERNAL COMBUSTION ENGINE

(71) Applicant: DAVIS GLOBAL ENGINES, LLC, Portland, OR (US)

(72) Inventor: Corey M. Davis, Wilsonville, OR (US)

(21) Appl. No.: 15/565,546

(22) PCT Filed: Oct. 4, 2017
(86) PCT No.: PCT/US17/55125

§ 371 Date: Oct. 10, 2017

Related U.S. Application Data
(60) Provisional application No. 62/404,107, filed on Oct. 4, 2016.
(60) Provisional application No. 62/403,900, filed on Oct. 4, 2016.

(51) Int. Cl. F02B 75/24

(52) U.S. Cl. CPC F02B 75/24; F02B 2075/025

(57) ABSTRACT

An internal combustion engine comprising a crankshaft rotatable about an axis, one or more pairs of cylinders opposed from each other on either side of the crankshaft, one or more pairs of pistons alternately moveable within the cylinders by combustion therein, and a common rod connecting the pair of pistons, the pistons and common rod being linearly slideable in a first direction. A linear bearing is disposed on the common rod between the pair of pistons and connects the common rod to the crankshaft, the linear bearing being slideable in a second direction normal to the first direction. As the pair of pistons alternately move within the cylinders, the crankshaft is driven by movement of the common rod and pair of pistons back and forth in the first direction and movement of the linear bearing back and forth in the second direction.

### RELATED APPLICATIONS

This application is a U.S. National Stage application under 35 U.S.C. § 371(c) of international PCT Application No. PCT/US2017/055125, filed Oct. 4, 2017, which claims priority to U.S. Patent Application No. 62/404,107, filed Oct. 4, 2016, and U.S. Patent Application No. 62/403,900, filed Oct. 4, 2016, the entire disclosures of which are incorporated herein by reference.

### BACKGROUND OF THE INVENTION

### 1. Field of the Invention

This invention relates generally to internal combustion engines, and more specifically, to an improved internal combustion engine providing a smaller swept volume throughout combustion and expansion while retaining the same total displacement over that of internal combustion engines of the prior art.

### 2. Description of Related Art

Internal combustion engines typically employ one or more pistons each coupled to a crankshaft by a connecting rod, each connecting rod having two pivot points to couple linear piston motion to rotational crankshaft motion via angular (less direct force vector) and rotational movement.

Referring now to FIG. 1, a portion of a typical internal combustion engine of the prior art is shown. Internal combustion engine 1000 comprises a cylinder 100 serving as the channel in the block that contains the piston 101, wherein the combustion takes place near the top of the cylinder, as shown in FIG. 1. As depicted, a single rotating assembly comprising a cylinder, piston and crankshaft is shown; however it should be understood by those skilled in the art that there may be 1 to 12 (or more) cylinders in a typical prior art engine. Piston 101 sweeps the length of the cylinder and compresses the air (and in some applications, air and fuel), so that when the compressed mixture is ignited, the resulting pressure drives the piston 101 downwards in the cylinder 100 in the direction of arrow 105, applying force to the connecting rod 103 which in turn applies force to the crankshaft 104, causing it to rotate. Crankshaft 104 actually drives the load of the vehicle or other device to which it is to power. It contains concentric main journals which ride in main bearings installed in the engine block (not shown, for clarity) and one or more offset rod journals for each piston 101, each containing rod bearings (not shown). It should be understood by those of ordinary skill in the art that the present invention is also applicable to direct injection applications, wherein the fuel is injected into the compressed air in conjunction with either spark ignition or compression ignition due to elevated air temperature as a result of air compression.

Wrist pin 102 contains a wrist pin bushing that connects the piston 101 to the connecting rod 103, creating a pivot point and replaceable low friction wear surface which allows the connecting rod 103 to swivel at the piston end as the piston 101 sweeps in reciprocating motion along the length of the cylinder 100. Connecting rod 103 directly couples the piston 101 to the crank shaft 104 at an offset rod journal. The end of the connecting rod adjacent crankshaft 104 contains a rod bearing and is fitted concentrically to the crankshaft rod journal, creating a second pivot point which allows the connecting rod 103 to swivel at the crankshaft 104 end as the crankshaft rotates.

Internal combustion engines typically have a thermal efficiency ranging from 15% to 40%, which results in significant emissions of waste heat, unburned fuel, particulates, and pollutants resulting from inefficient and incomplete combustion.

Conventional internal combustion engines utilize a small portion of the energy contained within the fuel they consume. The majority of the fuel's energy content is lost in the form of hot exhaust gas. For a given amount of work produced by an engine, the volume and temperature of the hot gas produced during the duration of this work represents the majority of the thermal energy which was not translated into mechanical energy.

Internal combustion engines of the prior art are limited in power produced per unit of engine displacement by the maximum safe operating range of exhaust gas temperature. In order to produce more torque at a given displacement, more air and fuel must be added resulting in increased exhaust gas volume and temperature. In order to further increase torque when maximum safe exhaust gas temperature is reached, engine displacement must be increased, resulting in increased exhaust gas volume for a given amount of torque.

Moreover, conventional internal combustion engines yield incomplete combustion, resulting in decreased thermal efficiency and increased emissions of particulates, raw fuel, and various chemical compounds resulting from a portion of the fuel introduced undergoing incomplete chemical reaction during combustion.

Therefore, a need exists for an improved internal combustion engine having increased thermal efficiency and a more confined combustion and expansion volume, resulting in higher mean effective pressure for the same amount of fuel.

### SUMMARY OF THE INVENTION

Bearing in mind the problems and deficiencies of the prior art, it is therefore an object of the present invention to provide an improved internal combustion engine which increases thermal efficiency over that of conventional internal combustion engines.

It is another object of the present invention to provide an improved internal combustion engine which provides a more confined combustion and expansion volume, resulting in higher mean effective pressure given the same amount of fuel.

A further object of the invention is to provide an internal combustion engine having a rotating assembly wherein piston motion relative to crankshaft motion results in a smaller swept volume throughout combustion and expansion while retaining the same total displacement.

It is yet another object of the present invention to provide an improved internal combustion engine which requires less fuel to produce a given amount of torque, without increasing exhaust gas temperature.

It is still yet another object of the present invention to provide an improved internal combustion engine having a common rod assembly connecting two pistons for linear motion along a plane and line and a linear bearing assembly assembled concentric to the crankshaft, the common rod assembly coupling linear piston motion to rotational crankshaft motion via linear and rotational movement.

Still other objects and advantages of the invention will in part be obvious and will in part be apparent from the specification.

The above and other objects, which will be apparent to those skilled in the art, are achieved in the present invention which is directed to an internal combustion engine comprising a crankshaft rotatable about an axis, one or more pairs of cylinders opposed from each other on either side of the crankshaft, one or more pairs of pistons alternately moveable within the cylinders by combustion therein, and a common rod connecting the pair of pistons, the pistons and common rod being linearly slideable in a first direction. A linear bearing is disposed on the common rod between the pair of pistons and connects the common rod to the crankshaft, the linear bearing being slideable in a second direction normal to the first direction. As the pair of pistons alternately move within the cylinders, the crankshaft is driven by movement of the common rod and pair of pistons back and forth in the first direction and movement of the linear bearing back and forth in the second direction.

The pair of cylinders and pair of pistons may be aligned coaxially along an axis extending in the first direction, and the crankshaft axis may be normal to the first direction and to the second direction. The common rod may include a pair of arms forming an opening through which the crankshaft extends, the opening having a height in the second direction greater than a width in the first direction and including slots extending normal to an axis extending in the first direction, wherein the linear bearing is slideable along the slots. The linear bearing may include opposite edges being slideable within the common rod opening slots.

The crankshaft may include a throw having a journal and the linear bearing may have an opening therein, wherein the journal is engaged with the opening in the linear bearing and is rotatably moveable therein. The linear bearing may be composed of two bearing body halves, each body half containing an inner and an outer replaceable wear surface.

The internal combustion engine may further include an exhaust valve disposed within each of the cylinders for releasing combustion byproducts after combustion occurs within the cylinders, and at least one intake port disposed within each of the cylinders for allowing air to enter the cylinder for combustion. In an embodiment, the swept volume of the piston in the cylinder after combustion increases more slowly as compared to an internal combustion engine having a piston rod connected directly to the crankshaft.

In another aspect, the present invention is directed to a sliding linear common rod rotating assembly, comprising a crankshaft rotatable about an axis, a pair of pistons being linearly slideable in a first direction, a common rod connecting the pistons and being linearly slideable with the pistons in the first direction, and a linear bearing disposed on the common rod between the pair of pistons, the linear bearing connecting the common rod to the crankshaft and being slideable in a second direction normal to the first direction, wherein the crankshaft is driven by movement of the common rod and pair of pistons back and forth in the first direction and movement of the linear bearing back and forth in the second direction.

The swept volume of the piston in the cylinder increases more slowly as compared to an internal combustion engine having a piston rod connected directly to the crankshaft.

In another aspect, the present invention is directed to a sliding linear common rod rotating assembly, comprising a sliding linear bearing that rides on a film of oil moving normal to the motion of pistons on the ends of a common rod assembly driving a crankshaft journal.

In yet another aspect, the present invention is directed to a method of building an internal combustion engine, comprising: providing a crankshaft rotatable about an axis, providing a pair of cylinders opposed from each other on either side of the crankshaft, providing a pair of pistons moveable within the cylinders by combustion therein, and providing a common rod for connecting the pair of pistons at opposite ends thereof along a first direction, the common rod having in a central portion thereof a linear bearing slideable in a second direction normal to the first direction. The method further comprises connecting the pair of pistons to opposite ends of the common rod, and connecting the linear bearing to the crankshaft, wherein as the pair of pistons alternately move within the cylinders the crankshaft may be driven by movement of the common rod and pair of pistons back and forth in the first direction and movement of the linear bearing back and forth in the second direction.

The pair of cylinders and pair of pistons may be aligned coaxially along an axis extending in the first direction. The common rod opening may include slots extending normal to an axis extending in the first direction, wherein the linear bearing is slideable along the slots. The common rod may further include a pair of arms forming an opening through which the crankshaft extends, the opening having a height in the second direction greater than a width in the first direction.

In still yet another aspect, the present invention is directed to a method of operating an internal combustion engine, comprising providing a crankshaft rotatable about an axis, a pair of cylinders opposed from each other on either side of the crankshaft, a pair of pistons alternately moveable within the cylinders by combustion therein, a common rod connecting the pair of pistons, the pistons and common rod being linearly slideable in a first direction, and a linear bearing disposed on the common rod between the pair of pistons, the linear bearing connecting the common rod to the crankshaft and being slideable in a second direction normal to the first direction. The method further comprises alternately igniting fuel in the cylinders above the pistons, and as the pair of pistons are alternately moved within the cylinders by ignition of the fuel, driving the crankshaft in rotational movement by movement of the common rod and pair of pistons back and forth in the first direction and movement of the linear bearing back and forth in the second direction.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of a portion of an internal combustion engine of the prior art.

FIGS. 2 and 2A are a plan view of an embodiment of the sliding linear internal combustion engine of the present invention, and an isolated plan view of the rotating assembly of the internal combustion engine of the present invention, respectively.

FIG. 3 is a cross-sectional plan view of the rotating assembly of FIG. 2A.

FIG. 4 is a top down view of FIG. 3 showing a pair of common rods and crankshaft throws.

FIG. 5 is a plan view of an embodiment of the sliding linear internal combustion engine of the present invention, showing intake ports and exhaust valves.

FIGS. 6-11 are plan views of the sliding linear internal combustion engine of the present invention, showing the rotation of the crankshaft and the position of the sliding linear assembly as the pistons transition between a position of top dead center and bottom dead center.

FIG. 12 is a line graph showing Swept Volume vs. Crankshaft Position of an embodiment of the sliding linear internal combustion engine of the present invention, in comparison with an exemplary internal combustion engine of the prior art.

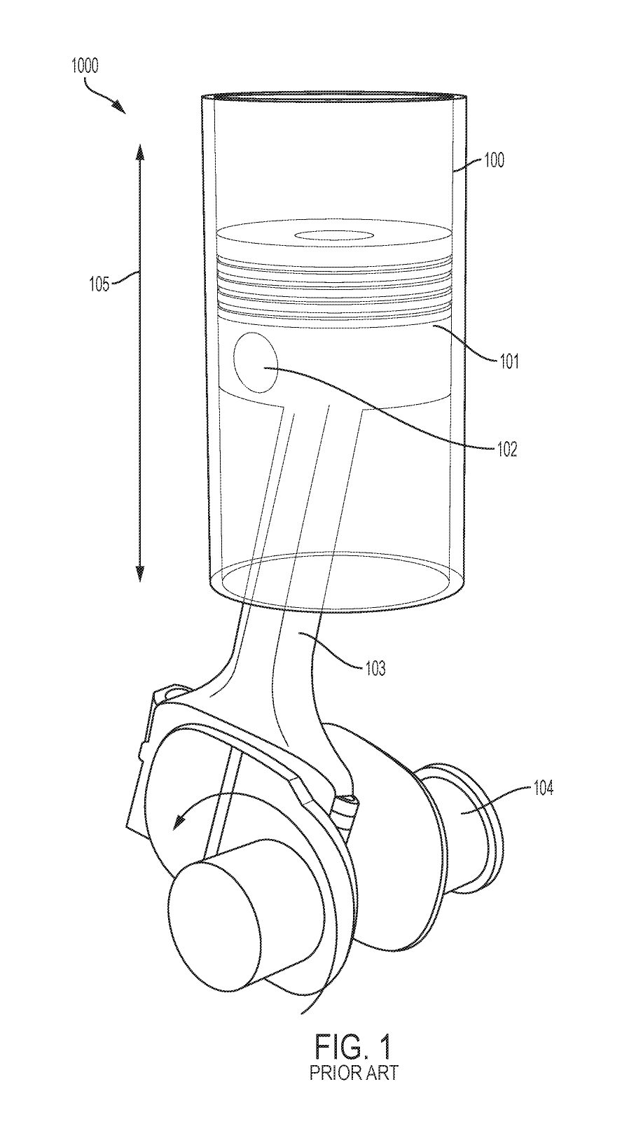

### DESCRIPTION OF THE EMBODIMENT(S)

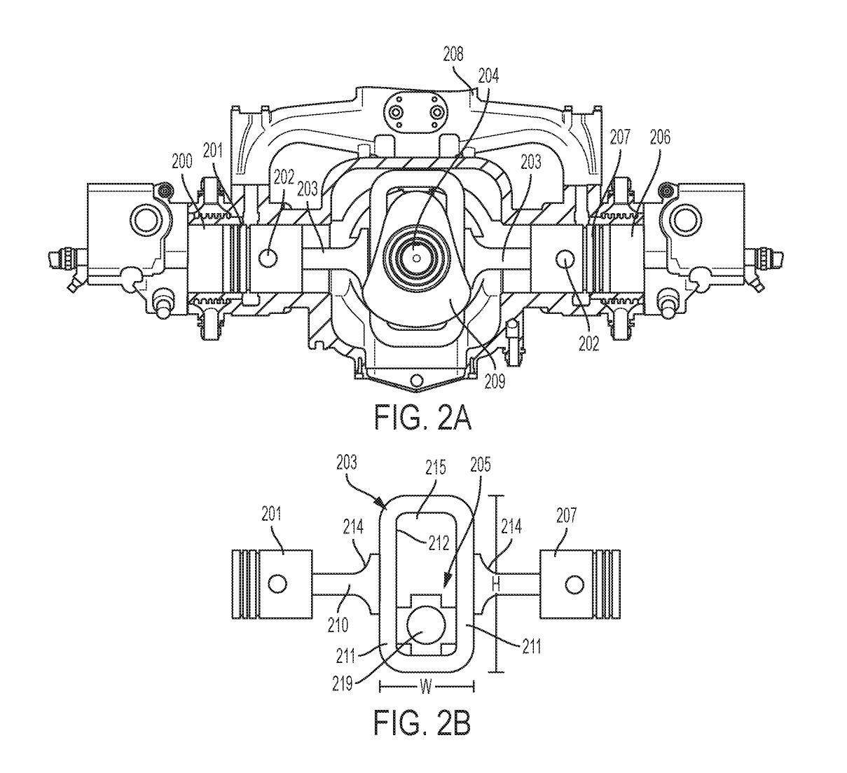

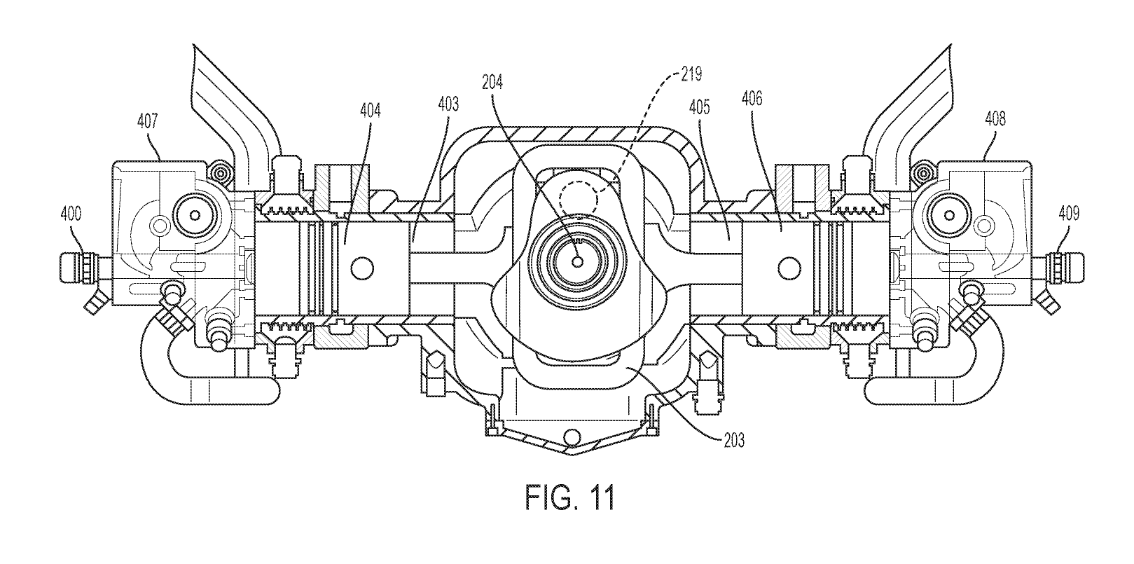

In describing the embodiments of the present invention, reference will be made herein to FIGS. 2-12 of the drawings in which like numerals refer to like features of the invention.

The present invention relates to an improved internal combustion engine or High Efficiency Sliding Linear Internal Combustion Engine (hereinafter referred to as the “SLIC Engine”), comprising an engine and rotating assembly wherein the piston motion relative to crankshaft motion results in a substantially smaller swept volume throughout combustion and hot gas expansion processes while retaining the same total displacement, thereby providing a comparatively more confined combustion and expansion volume resulting in higher mean effective pressure given the same amount of fuel.

Certain terminology is used herein for convenience only and is not to be taken as a limitation of the invention. For example, words such as “top,” “bottom,” “upper,” “lower,” “left,” “right,” “horizontal,” “vertical,” “upward,” and “downward” merely describe the configuration shown in the drawings. For purposes of clarity, the same reference numbers will be used in the drawings to identify similar elements.

FIGS. 2 and 2A depict one embodiment of a SLIC Engine of the present invention. Cylinders 200, 206 comprise channels in the block that contain the pistons 201, 207, respectively, wherein the combustion takes place near the tops of the cylinders (to the left of piston 201 and to the right of piston 207, respectively, as shown). As shown in FIG. 2, in an embodiment, opposing cylinders 200, 206 are in direct axial alignment, which is in contrast to internal combustion engines of the prior art wherein the cylinders are typically staggered along the longitudinal axis of the engine block. In an embodiment, there may be 1 to 12 (or more) pairs of directly opposing cylinders in each SLIC Engine. In operation, pistons 201, 207 are alternately moveable within the cylinders 200, 206 and sweep in reciprocating motion along the length of the cylinders within the cylinder bore and compress the air, so that when fuel is introduced and the compressed mixture is ignited (utilizing spark ignition or compression ignition), the resulting pressure drives the first piston 201 downwards in the cylinder applying force to the common rod assembly 203, which in turn applies force directly to the opposing piston 207, as well as applying force to SLIC linear bearing assembly 205 and causing the crankshaft 204 to rotate. As will be described in more detail below, crankshaft 204 is rotatable about an axis and is positioned such that the crankshaft axis is normal to the axes of pistons 201, 207, and the crankshaft is caused to rotate by movement of a common rod assembly 203 back and forth in a first direction, in conjunction with movement of a sliding linear bearing assembly 205 positioned within an opening defined by the connector rod assembly in a second direction normal to the first direction. Wrist pins 202 connect the pistons 201, 207 to the straight portions of connecting rod 203, allowing the pistons to precisely align to the cylinder bores to compensate for any axial misalignment of common rod assembly 203 with the cylinder bores. There is virtually no motion at the wrist pins 202, as compared to internal combustion engines of the prior art.

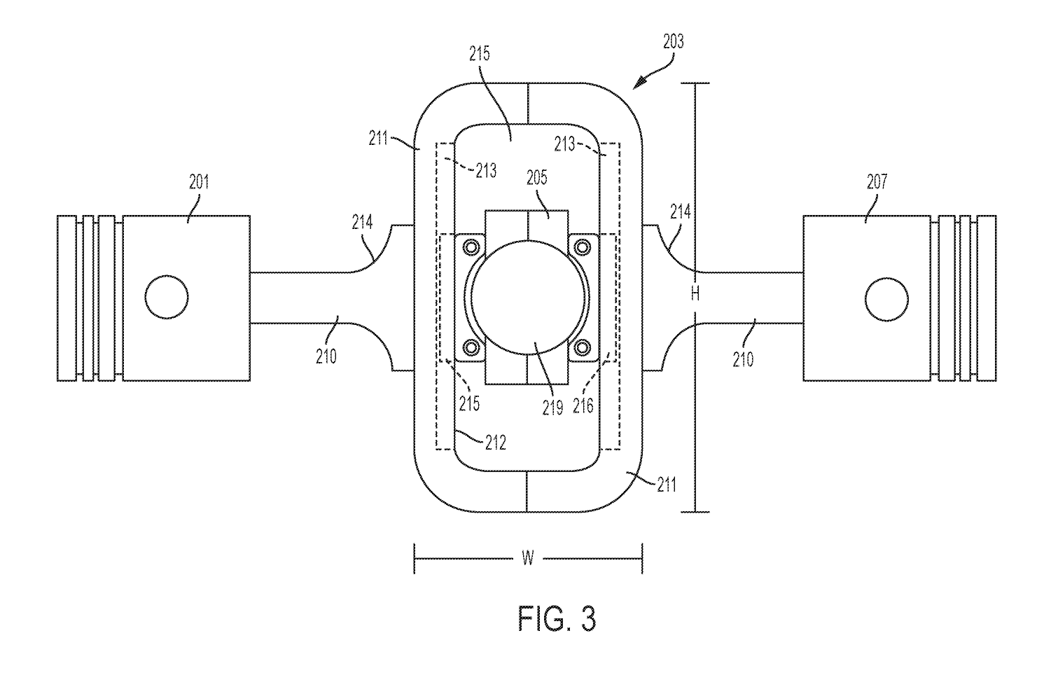

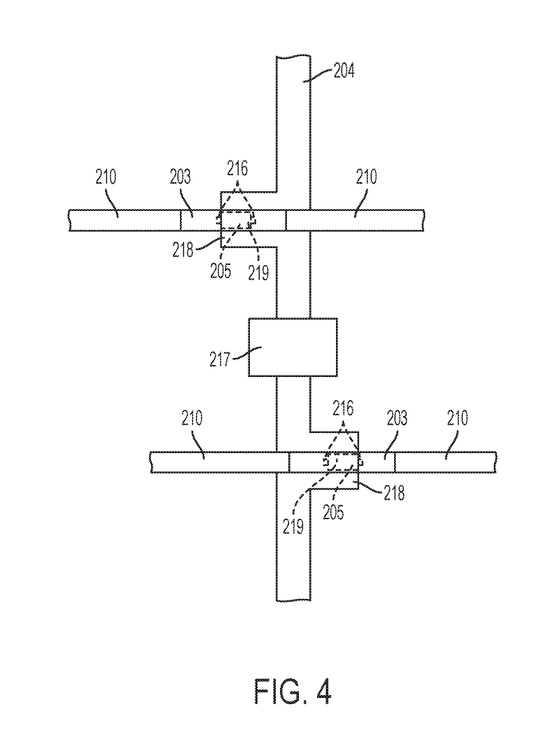

As best seen in FIGS. 2A and 3, a common rod assembly 203 connects the pistons 201, 207 to the crankshaft 204 via SLIC main linear bearing assembly 205. Common rod assembly 203 is slideable linearly in a first direction as the pistons alternately fire caused by combustion within the cylinders (i.e. between left-hand and right-hand positions, as shown in FIG. 2). In an embodiment, the motion of common rod assembly 203 (as well as the motion of pistons 201, 207) is along a single plane along a single line, back and forth only. Crankshaft 204 transmits power to the load which the engine is driving. The crankshaft 204 contains concentric main journals 217 which ride in main bearings installed in engine block (FIG. 4) and one or more offset rod journals 219 on a throw or crank arm 218, one for each set of two pistons 201, 207. Crankshaft 204 is internally or externally balanced with crankshaft 204 and SLIC main bearing subassembly 205 being balanced as a unit with integral crankshaft counterweights 209, resulting in smooth consistent motion regardless of engine speed (FIG. 2).

Common rod assembly 203 connects both pistons 201, 207 together and comprises a pair of straight rod portions 210 axially aligned with the axes of the pistons 201, 207, each straight rod portion having arms 211 extending normal to the piston axes and forming an opening 215 for receiving the linear bearing assembly 205 therebetween. As shown in FIG. 2A, opening 215 has a height H in the second direction greater than its width W in the first direction. Each straight rod portion 210 further includes a pair of flanges 214 for connecting to arm 211. In an embodiment, common rod assembly 203 may be comprised of two halves positioned around the sliding linear bearing 205. The halves of common rod assembly 203 may be manufactured separately, or alternatively, may be manufactured as one piece and subsequently fractured into two pieces and reassembled around linear bearing 205. Each common rod assembly half may contain a wrist pin bushing for connecting to the adjacent piston 201, 207.

A sliding linear bearing 205 is disposed between the pistons 201, 207 and connects the common rod assembly 203 to the offset journal 219 of crankshaft 204, which extends through opening 215 defined between arms 211. Sliding linear bearing 205 is slideable in a direction normal to the movement of the common rod assembly 203 during operation of the SLIC Engine, and slides within a pair of channels or slots 213 on opposite sides of the opening 215 and extending normal to the piston axes on the inner surface 212 of connector rod assembly arms 211 (FIG. 3). In at least one embodiment, the linear bearing rides on a film of oil and moves in a direction normal to the motion of the pistons on the ends of the common rod assembly, which drives the crankshaft offset journal 219. As further shown in FIG. 3, linear bearing 205 has edges 216 slideable within slots 213. Similar to the connector rod assembly 203, bearing assembly 205 may be comprised of two bearing body halves (each containing both an inner and an outer replaceable wear surface), the two bearing body halves being manufactured separately, or alternatively, the bearing body may be manufactured as one piece and subsequently fractured into two pieces which are assembled concentric to the crankshaft rod journal and utilize a hydrodynamic oil bearing similar to connecting rods of the prior art, and also slides up and down on a hydrodynamic oil cushion, functioning similar to a linear hydrodynamic bearing, inside the opening defined between the connect rod assembly arms 211. It should be understood by those of ordinary skill in the art that the present invention is not limited to hydrodynamic bearings and that bearings other than hydrodynamic bearings may also be used, such as roller bearings or ball bearings as in motorcycle engines, for example. The crankshaft rod journal is engaged with an opening defined between the linear bearing 205 halves and is rotatably moveable therein.

FIG. 4 depicts a top down view of the rotating assembly of FIG. 3, showing a pair of common rods and crankshaft throws. The opposing cylinders and pistons coupled to the common rods are not shown, for clarity. FIG. 4 shows only a portion of the engine block comprising a pair of common rods, each coupling a pair of pistons; however, it should be understood by those of ordinary skill in the art that an embodiment of the present invention may comprise 1 to 12 (or more) pairs of opposing cylinders (and thus pistons).

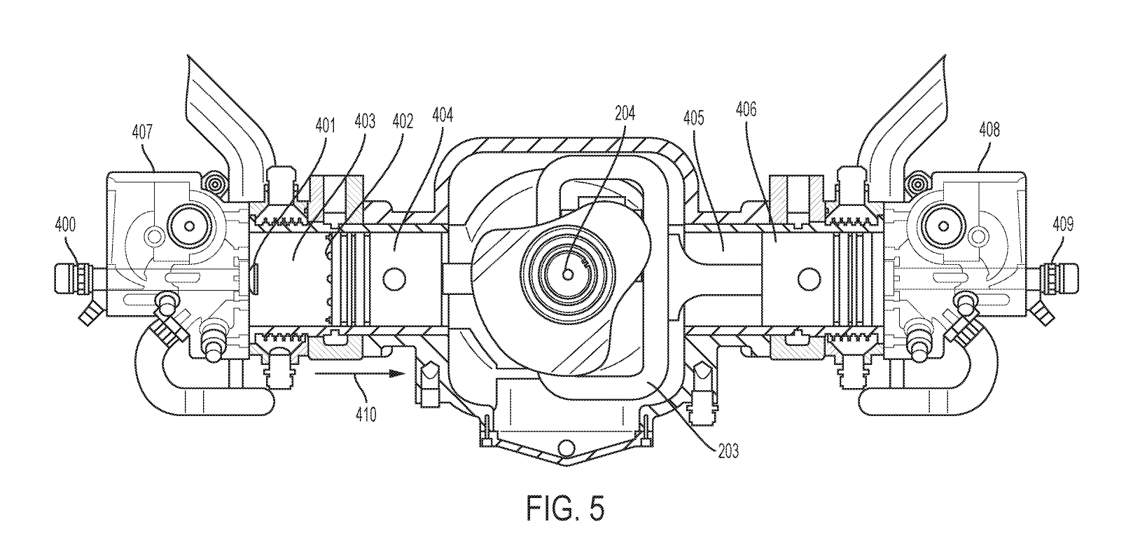

FIG. 5 depicts an embodiment of SLIC Engine of the present invention with intake ports and exhaust valve detail. As shown in FIG. 5, the connector rod assembly 203 is moving to the right, as indicated by arrow 410.

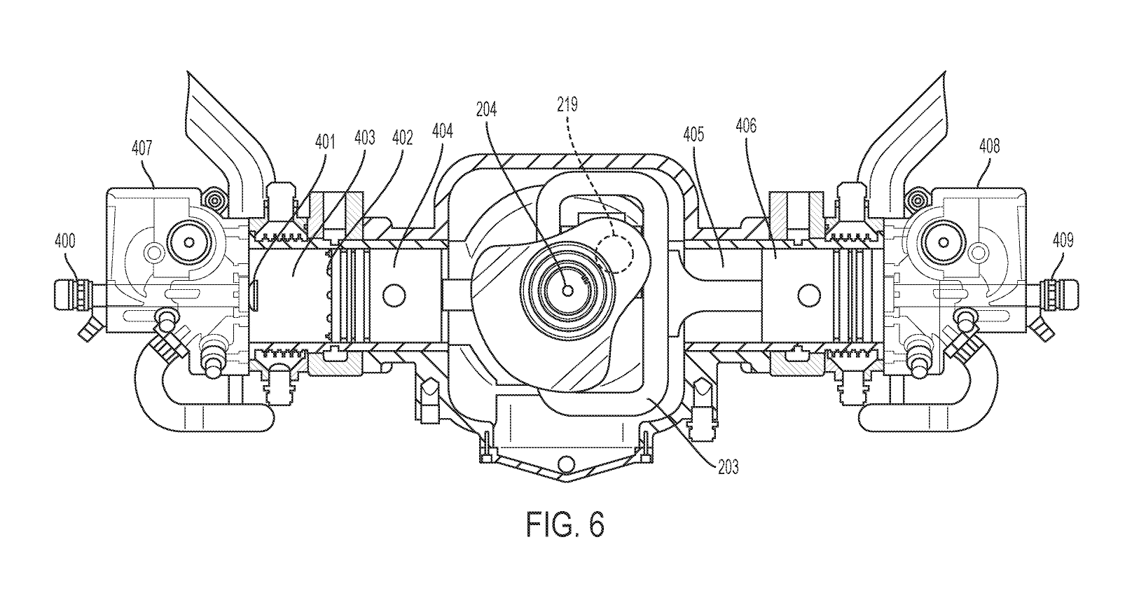

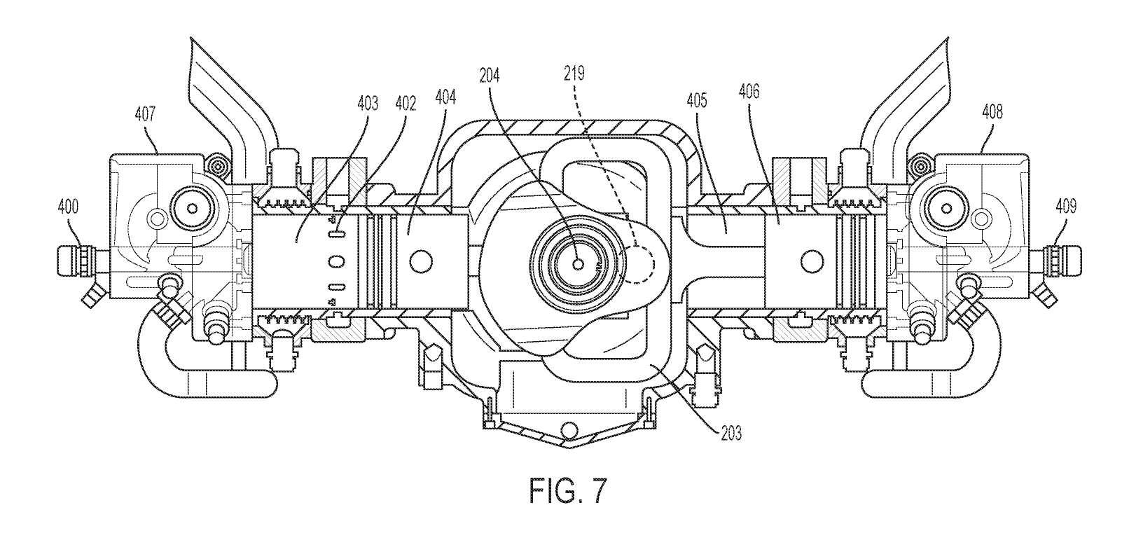

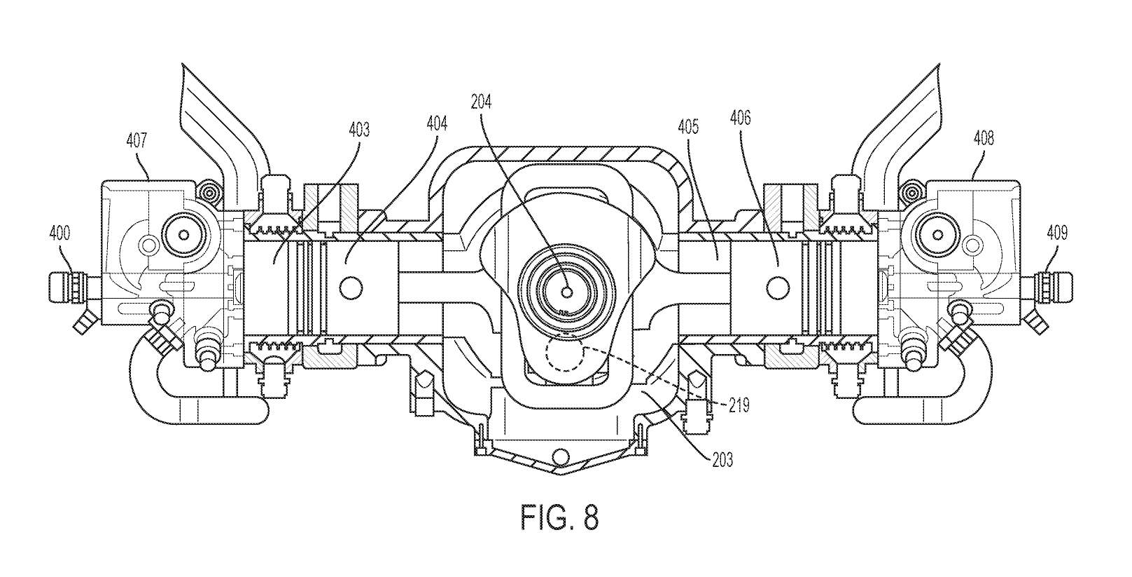

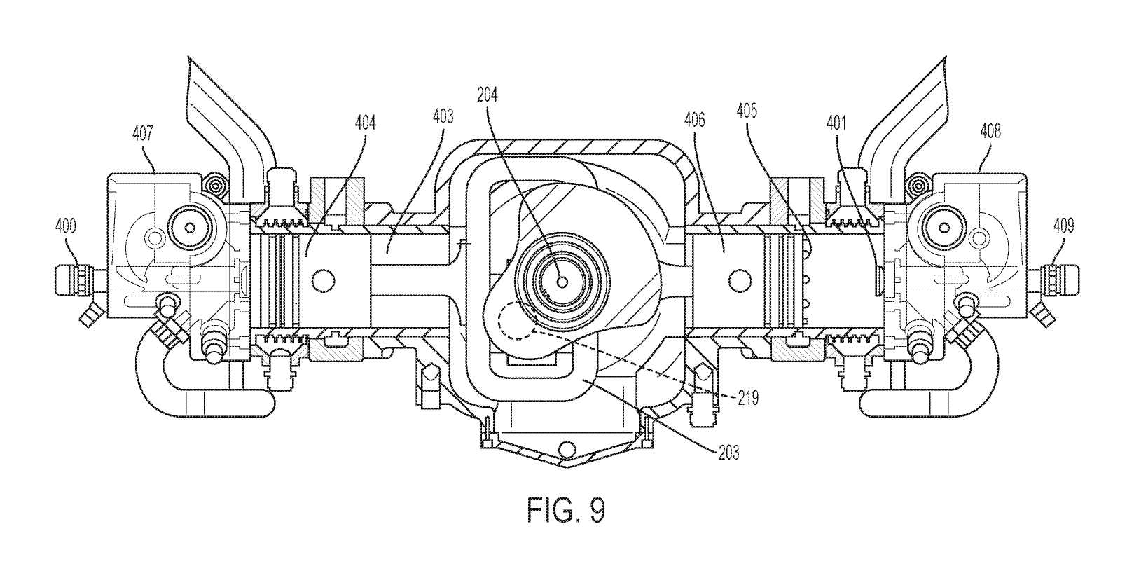

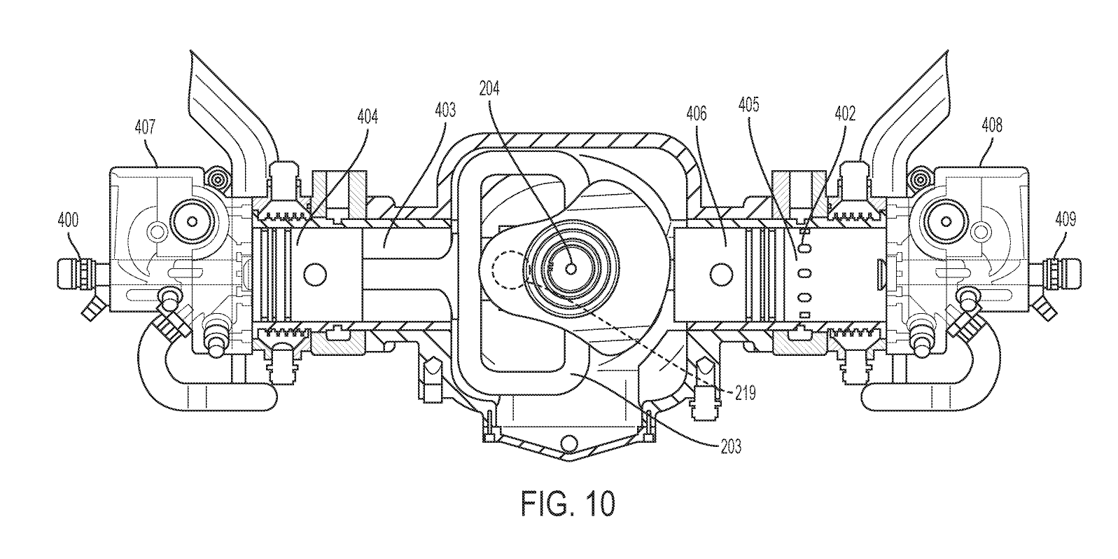

FIGS. 6-11 depict the SLIC Engine of the present invention at various stages of operation during different portions of the piston stroke, i.e., the travel of the piston along the cylinder between top dead center (“TDC”) and bottom dead center (“BDC”). As shown in FIG. 6, fuel injector 409 has just fired in the cylinder 405 as piston 406 approaches TDC. Simultaneously, piston 404 in cylinder 403 is moving away from cylinder head 407, completing a power stroke and initiating an exhaust as the exhaust valve 401 opens to release exhaust gases. As piston 404 sweeps toward BDC, exhaust valve 401 opens just early enough to allow exhaust gases to escape causing cylinder pressure to decrease below the level of pressure in intake manifold 208 (not shown in FIGS. 6-11, but shown in FIG. 2) before intake ports 402 are uncovered (FIG. 6). As cylinder pressure falls below pressure in the intake manifold 208, piston 404 continues to sweep toward BDC, now uncovering intake ports 402 (FIG. 7). Air inside the intake manifold 208, which has been pressurized by a supercharger, begins flowing into the intake ports 402, flushing out remaining exhaust gases as piston 404 approaches BDC, reaches BDC and reverses to begin sweeping back toward TDC. Exhaust gases continue to be flushed from the cylinder until exhaust valve 401 closes (FIGS. 7 and 8). Pressurized air continues to flow from the intake manifold 208 through the intake ports 402, filling the cylinder with air until piston 404 covers the intake ports 402 once again (FIG. 8). As the piston continues to sweep back toward TDC, the intake charge is compressed (FIG. 9). Near TDC, fuel injector 400 begins injecting fuel (FIG. 9). Multiple fuel injection events continue until fuel injection cutoff (several degrees after TDC; FIG. 10) and then the whole cycle repeats.

During operation, as pistons 404, 406 are alternately driven within cylinders 403, 405, the crankshaft 204 is driven to rotation by movement of the common rod assembly 203 back and forth along the first plane and line in a first direction in conjunction with movement of the sliding linear bearing 205 in a second direction normal to the first line and direction (i.e. up and down, as shown in FIG. 3). Pistons 404, 406 each fire during one revolution of the crankshaft 204.

One embodiment of the SLIC Engine of the present invention employs a crankshaft, one or more common rod assemblies, each having a pivot point only at the wrist pins to couple linear piston motion to rotational crankshaft motion via linear (more direct force vector) and rotational movement. Each common rod assembly connects two pistons together as a unit. In operation, as one piston approaches TDC, the other piston is approaching BDC. The embodiment shown is employed in a two stroke or two cycle engine, wherein the end of the combustion stroke and the beginning of the compression stroke happen simultaneously and the power cycle (up and down movement) of the piston is completed during only one crankshaft revolution. Alternatively, the present invention may be employed in four stroke or four cycle engines where the separate piston strokes are intake, compression, combustion and exhaust.

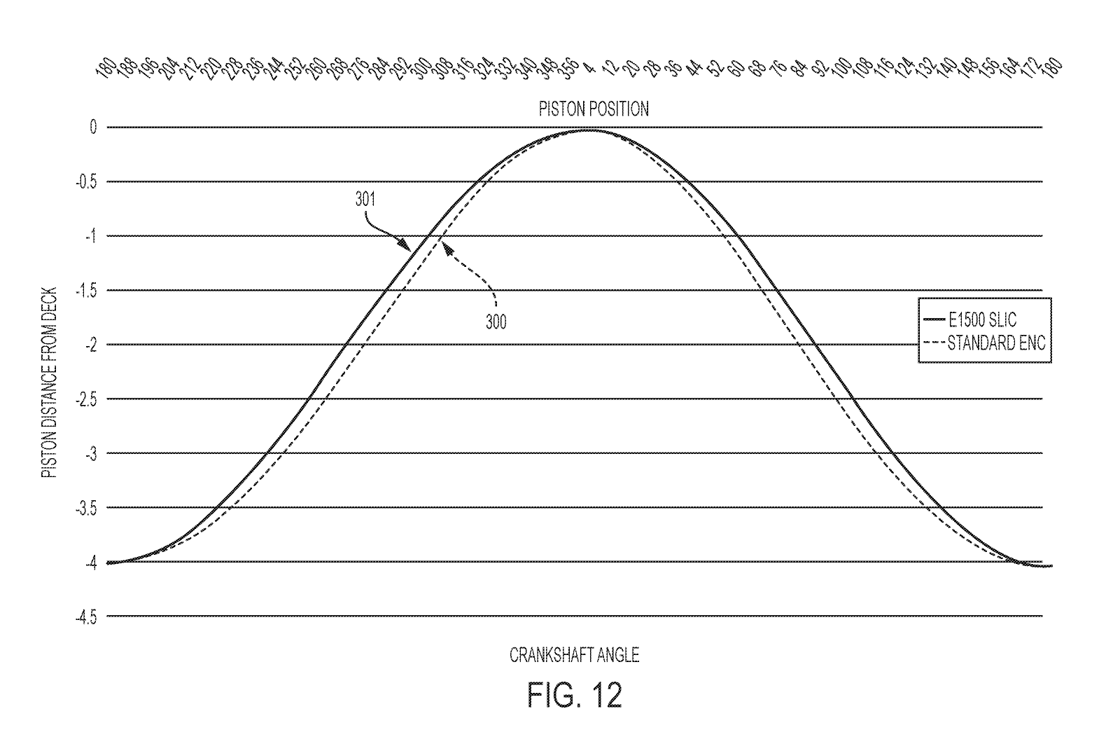

FIG. 12 shows a line graph depicting Swept Volume versus Crankshaft Position in one embodiment of a SLIC Engine 301 of the present invention as compared to a linear combustion engine of the prior art 300 of the exact same bore and stroke. The Swept Volume curve of the prior art engine 300 clearly illustrates how swept volume increases more rapidly and remains consistently greater from top dead center (“TDC”) almost all the way to bottom dead center (“BDC”), resulting in a consistently lower mean effective pressure (“MEP”) given the same starting pressure. By comparison, the Swept Volume curve of the SLIC Engine 301 clearly illustrates how swept volume increases more slowly and remains consistently smaller from TDC almost all the way to BDC. This results in a consistently higher MEP given the same starting pressure. As a result, the SLIC Engine 301 will always be able to produce more torque than prior art engines given the same bore, stroke, and starting pressure.

Thus, the present invention achieves one or more of the objects above. The present invention produces reduced parasitic drag realized through a decrease in angular loading of piston against cylinder bore and alteration of the relationship between piston position versus crankshaft rotation yielding more complete combustion, increased torque, and a more efficient conversion from thermal to mechanical energy during expansion of hot combustion gases.

More complete combustion is a result of the piston remaining closer to TDC throughout the combustion and expansion portions of each revolution of the crankshaft, when compared to prior art rotating assemblies. By having less piston travel distance for more degrees of crankshaft rotation during each combustion event, the combustion chamber volume increases at a slower rate given the same engine speed, resulting in more time for the fuel to be fully consumed and thereby substantially reduces harmful combustion byproducts and environmental pollutants which typically result from incomplete combustion in prior art engines. Following combustion, the piston then accelerates to a higher mid-stroke velocity than prior art engines, resulting in a more rapid expansion and cooling of hot combustion gases.

The combustion chamber volume increases more slowly per degree of crankshaft rotation than prior art systems, therefore the same cylinder pressure in both systems will impart more mechanical energy to the crankshaft in the SLIC Engine system of the present invention than in prior art systems and provide increased torque.

As a result of the piston accelerating more rapidly and reaching a higher mid-stroke velocity as it sweeps downward away from TDC, in conjunction with the increased time for fuel to be fully consumed while the piston is still near TDC, the present invention provides more rapid expansion of hot combustion gases over engines of the prior art. As fuel has been fully consumed before substantial increase in combustion chamber volume and piston acceleration, the resulting rapid expansion causes a rapid decrease in hot gas temperature utilizing more of the available thermal energy.

In internal combustion engines of the prior art, piston acceleration and deceleration near TDC are not equal to piston acceleration and deceleration near BDC. This means that the rotating assembly will always be unbalanced to some degree. In the SLIC Engine of the present invention, the piston acceleration and deceleration at TDC and BDC are equal, resulting in improved reciprocating force distribution throughout each rotation of the crankshaft. In one embodiment, the piston acceleration and deceleration at TDC and BDC are canceled out entirely with a system of counter-balance weights synchronized with the crankshaft. This means the SLIC Engine has improved noise/vibration/harshness as compared to prior art engines. Moreover, the peak acceleration and deceleration of the piston at a given engine speed is substantially lower in the SLIC Engine, resulting in reduced strain on rotating assembly components.

The SLIC Engine of the present invention enables thermal efficiencies greater than 50%. Because a higher mean effective pressure is achieved relative to a given amount of fuel, less fuel is required to produce the same amount of torque. An engine which requires less fuel also requires less air, thus reducing both exhaust gas temperature and volume for a given amount of torque.

Due to the substantial reduction of fuel (and thus air) required to produce a given amount of torque, substantially smaller and lighter engines can be used to produce the same amount of torque as larger internal combustion engines of the prior art, without increasing exhaust gas temperature beyond safe operating limits.

While the present invention has been particularly described, in conjunction with specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. An internal combustion engine, comprising:
a crankshaft rotatable about an axis;
one or more pairs of cylinders opposed from each other on either side of the crankshaft;
one or more pairs of pistons alternately moveable within the cylinders by combustion therein;
a common rod connecting the pair of pistons, the pistons and common rod being linearly slideable in a first direction;
a linear bearing disposed on the common rod between the pair of pistons, the linear bearing connecting the common rod to the crankshaft and being slideable in a second direction normal to the first direction; and
wherein as the pair of pistons alternately move within the cylinders the crankshaft is driven by movement of the common rod and pair of pistons back and forth in the first direction and movement of the linear bearing back and forth in the second direction.

2. The internal combustion engine of claim 1 wherein the pair of cylinders and pair of pistons are aligned coaxially along an axis extending in the first direction.

3. The internal combustion engine of claim 2 wherein the crankshaft axis is normal to the first direction and to the second direction.

4. The internal combustion engine of claim 1 wherein the common rod includes a pair of arms forming an opening through which the crankshaft extends.

5. The internal combustion engine of claim 4 wherein the common rod opening includes slots extending normal to an axis extending in the first direction, and wherein the linear bearing is slideable along the slots.

6. The internal combustion engine of claim 5 wherein the linear bearing includes opposite edges, the edges being slideable within the common rod opening slots.

7. The internal combustion engine of claim 1 wherein the crankshaft includes a throw having a journal and the linear bearing has an opening therein, and wherein the journal is engaged with the opening in the linear bearing and is rotatably moveable therein.

8. The internal combustion engine of claim 4 wherein the common rod opening has a height in the second direction greater than a width in the first direction.

9. The internal combustion engine of claim 1 further including a pair of wrist pins connecting the pair of pistons to the common rod.

10. The internal combustion engine of claim 1 wherein the linear bearing is composed of two bearing body halves, each body half containing an inner and an outer replaceable wear surface.

11. The internal combustion engine of claim 1 further including:
an exhaust valve disposed within each of the cylinders, the exhaust valve releasing combustion byproducts after combustion occurs within the cylinders; and
at least one intake port disposed within each of the cylinders, the intake port allowing air to enter the cylinder for combustion.

12. The internal combustion engine of claim 1 wherein a smaller swept volume per degree of crankshaft rotation near Top Dead Center is achieved before and during combustion and expansion as compared to an internal combustion engine having a piston rod connected directly to a crankshaft.

13. A sliding linear common rod rotating assembly, comprising:
a crankshaft rotatable about an axis;
a pair of pistons being linearly slideable in a first direction;
a common rod connecting the pistons and being linearly slideable with the pistons in the first direction;
a linear bearing disposed on the common rod between the pair of pistons, the linear bearing connecting the common rod to the crankshaft and being slideable in a second direction normal to the first direction; and
wherein the crankshaft is driven by movement of the common rod and pair of pistons back and forth in the first direction and movement of the linear bearing back and forth in the second direction.

14. The sliding linear common rod rotating assembly of claim 13 wherein a smaller swept volume per degree of crankshaft rotation near Top Dead Center is achieved before and during combustion and expansion as compared to an internal combustion engine having a piston rod connected directly to a crankshaft.

15. A sliding linear common rod rotating assembly, comprising:
a sliding linear bearing that rides on a film of oil moving normal to the motion of pistons on the ends of a common rod assembly driving a crankshaft journal.

16. A method of building an internal combustion engine, comprising:
providing a crankshaft rotatable about an axis;
providing a pair of cylinders opposed from each other on either side of the crankshaft;
providing a pair of pistons moveable within the cylinders by combustion therein;
providing a common rod for connecting the pair of pistons at opposite ends thereof along a first direction, the common rod having in a central portion thereof a linear bearing slideable in a second direction normal to the first direction;
connecting the pair of pistons to opposite ends of the common rod; and
connecting the linear bearing to the crankshaft;
wherein as the pair of pistons alternately move within the cylinders the crankshaft may be driven by movement of the common rod and pair of pistons back and forth in the first direction and movement of the linear bearing back and forth in the second direction.

17. The method of claim 16 wherein the pair of cylinders and pair of pistons are aligned coaxially along an axis extending in the first direction.

18. The method of claim 16 wherein the common rod opening includes slots extending normal to an axis extending in the first direction, and wherein the linear bearing is slideable along the slots.

19. The method of claim 18 wherein the common rod includes a pair of arms forming an opening through which the crankshaft extends, the opening having a height in the second direction greater than a width in the first direction.

20. A method of operating an internal combustion engine, comprising:
providing a crankshaft rotatable about an axis, a pair of cylinders opposed from each other on either side of the crankshaft, a pair of pistons alternately moveable within the cylinders by combustion therein, a common rod connecting the pair of pistons, the pistons and common rod being linearly slideable in a first direction, and a linear bearing disposed on the common rod between the pair of pistons, the linear bearing connecting the common rod to the crankshaft and being slideable in a second direction normal to the first direction;
alternately igniting fuel in the cylinders above the pistons; and
as the pair of pistons are alternately moved within the cylinders by ignition of the fuel, driving the crankshaft in rotational movement by movement of the common rod and pair of pistons back and forth in the first direction and movement of the linear bearing back and forth in the second direction.

21. A sliding linear common rod assembly for an internal combustion engine, the common rod assembly connected directly to a crankshaft journal via a bearing that travels linearly perpendicular to the common rod, the common rod assembly achieving a smaller swept volume per degree of crankshaft rotation near Top Dead Center during combustion and expansion as compared to an internal combustion engine having a piston rod connected directly to a crankshaft.

22. A sliding linear common rod assembly for an internal combustion engine, the common rod assembly connected directly to a crankshaft journal via a bearing that travels linearly perpendicular to the common rod, the common rod assembly achieving a smaller swept volume per degree of crankshaft rotation and the swept volume increasing more slowly from Top Dead Center to about 90 degrees after Top Dead Center, as compared to an internal combustion engine having a piston rod connected directly to a crankshaft.
